(19) United States
(12) Patent Application Publication
(10) Pub. No.: US 2026/0007957 A1
(43) Pub. Date: Jan. 8, 2026

(54) GAME CONTROLLER

(71) Applicant: QANBA USA, LLC, Daly City, CA (US)

(72) Inventors: Jeffrey LYO, Daly City, CA (US); Kai Liu, Daly City, CA (US); Xiang Long Zhong, Shenzhen (CN)

(21) Appl. No.: 19/258,840

(22) Filed: Jul. 2, 2025

(30) Foreign Application Priority Data
Jul. 3, 2024 (CN) 2024215683734

(51) Int. Cl. A63F 13/24

(52) U.S. Cl. CPC A63F 13/24

(57) ABSTRACT

The present disclosure discloses a switch layout for a controller, which includes a control panel and a plurality of switches arranged on the control panel, a first switch combination area and a second switch combination area are formed on the control panel, the first switch combination area is provided with a first switch combination, the second switch combination area is provided with a second switch combination, the first switch combination includes four switches arranged in a first preset pattern, the second switch combination includes four switches arranged in a second preset pattern and four switches arranged in a third preset pattern. In this way, the controller of the present disclosure can improve a user's operating experience as a whole.

### CROSS-REFERENCE TO RELATED APPLICATION(S)

The present application claims priority to and the benefit of Chinese Patent Application No. 2024215683734, filed at the China National Intellectual Property Administration on Jul. 3, 2024, the entire disclosure of which is incorporated herein by reference.

### TECHNICAL FIELD

The present disclosure relates to the field of a game peripheral, and for example, a game controller.

### BACKGROUND

Switches of a game controller are usually set at specific positions according to pressing habits or preference of a user. However, the arrangement or layout of the switches on the game controller needs to be improved to better be adapted to operating needs of the user.

### SUMMARY

An object of the present disclosure is to provide a game control device with a new switch layout capable of improving the user's operation experience to solve the above-mentioned problems.

The present disclosure achieves the above-mentioned object with the following technical solutions:

One aspect of the present disclosure may provide a controller. The controller may include a control panel and a plurality of switches arranged on the control panel, and where the control panel may include a first switch combination area and a second switch combination area, the first switch combination area may include a first plurality of switches, the second switch combination area may include a second plurality of switches, the first plurality of switches may include one or more switches arranged in a first preset pattern, and the second plurality of switches may include one or more switches arranged in a second preset pattern and one or more switches arranged in a third preset pattern.

In one or more embodiments, a sixth switch may be arranged at a bottom end of the control panel between the first switch combination area and the second switch combination area.

In one or more embodiments, the control panel may have a first side and a second side opposite the first side, and the central axis may be between first side and the second side. The second switch combination area may be between the central axis and the second side of the control panel, and the second preset pattern and the third preset pattern may be a line that forms a non-perpendicular angle with respect to the central axis and the second side.

In one or more embodiments, the second preset pattern and the third preset pattern may be an arc shape which may have a curvature close to zero, and the second preset pattern and the third preset pattern have the same curvature.

In one or more embodiments, the one or more switches arranged in the first preset pattern are arranged in an arc shape and are substantially located on same horizontal level as the one or more switches arranged in the second preset pattern.

In one or more embodiments, the controller may further include a seventh switch with a largest surface area and/or volume arranged in the second switch combination area, and the seventh switch may be arranged adjacent to the sixth switch.

In one or more embodiments, the controller may further include a fifth switch arranged in the first switch combination area, and the fifth switch may be arranged adjacent to the sixth switch.

In one or more embodiments, the controller may have a sixteenth switch provided above the one or more switches arranged in the first preset pattern, and a seventeenth switch and an eighteenth switch provided above the one or more switches arranged in the second preset pattern and the one or more switches arranged in the third preset pattern.

In one or more embodiments, the sixteenth switch, the seventeenth switch, and the eighteenth switch may be non-functional switches.

In one or more embodiments, the plurality of switches may be spaced apart from each other.

Another aspect of the present disclosure may provide a gaming system. The gaming system may include a controller, where the controller may include a control panel and a plurality of switches arranged on the control panel. The control panel may include a first switch combination area and a second switch combination area, the first switch combination area and the second switch combination area being on opposite sides of a central axis of the control panel. The first switch combination area may include a first plurality of switches, and the second switch combination area mauy include a second plurality of switches. The first plurality of switches may include one or more switches arranged in a first preset pattern, and the second plurality of switches may include one or more switches arranged in a second preset pattern and one or more switches arranged in a third preset pattern.

In the present disclosure, the first plurality of switches arranged in the first switch combination area may be controlled by a user's left hand, and the second plurality of switches arranged in the second switch combination area may be controlled by the user's right hand. The one or more switches are arranged in the first preset pattern to adapt to the operating feel of the user's left hand, and the one or more switches are arranged in the second preset pattern and the third preset pattern to adapt the operating feel of the user's right hand. In this way, the controller of the present disclosure may improve the user's operating experience as a whole.

### BRIEF DESCRIPTION OF THE DRAWINGS

To more clearly illustrate the technical solutions in one or more embodiments of the present disclosure or in the existing technology, the following will briefly introduce the drawings needed for the description of the one or more embodiments or the existing technology. The drawings described below are only some embodiments of the present disclosure. For a person of ordinary skill in the art, other drawings may be obtained based on these drawings without creative efforts.

FIG. 1 is a schematic diagram of an example controller, according to one or

more embodiments of the present disclosure.

FIG. 2 is a schematic diagram of example switches of the controller, according to one or more embodiments of the present disclosure.

FIG. 3 is a schematic diagram of example switches of the controller, according to one or more embodiments of the present disclosure.

1. controller; 10. switch area; 20. function area; 30. support area; 11. switches; 12. control panel; A1. first switch combination area; A2. second switch combination area; and L. central axis.

### DETAILED DESCRIPTION

In order to make the objects, technical solutions and advantages of the present disclosure clear, the technical solutions of the present disclosure will be described in detail below. Apparently, the embodiments described herein are only part of the embodiments of the present disclosure, not all of them. Based on these embodiments of the present disclosure, all other embodiments or implementations obtained by a person of ordinary skill in the art without creative efforts should fall within the scope of protection of the present disclosure.

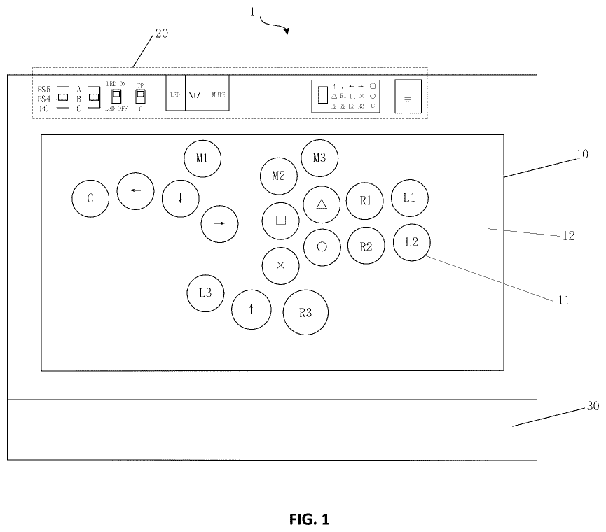

FIG. 1 is a schematic diagram of an example controller, according to one or more embodiments of the present disclosure.

FIG. 1 shows a controller 1, for example, a game control device having a plurality of switches arranged in a layout that adapts to a user's preference. In some embodiments, the controller 1 may be referred to as a game control device, a game keyboard, a flat keyboard, a control keyboard, and/or the like.

The controller 1 may include a switch area 10, a function area 20, and a support area 30. The switch area 10 may include a plurality of switches 11 and a control panel 12, in which the plurality of switches 11 arranged on the control panel 12.

In some embodiments, the control panel 12 may have a preset shape. The preset shape may be a rectangular shape, an irregular shape, and/or the like. In some embodiments, the plurality of switches 11 may be relatively evenly distributed on the control panel 12.

The function area 20 may include a plurality of function switches, such as an indicator switch, a transition switch, an adjustment switch for assigning a function to a non-functional switch (e.g., exchanging functions between switches), and/or the like.

The support area 30 may be used to support the user's hand and/or wrist.

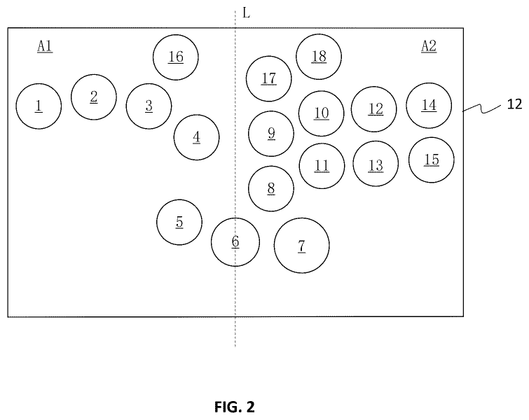

FIG. 2 is a schematic diagram of example switches of the controller, according to one or more embodiments of the present disclosure. The control panel 12 may include a first switch combination area A1 and a second switch combination area A2 defined via a central axis L, with the first switch combination area A1 on a first side of the central axis L (e.g., left side as shown in FIG. 2) and the second switch combination area A2 on a second side of the central axis L (e.g., right side, as shown in FIG. 2). For example, the first switch combination area A1 may include a first plurality of switches, and the second switch combination area A2 may include a second plurality of switches.

In some embodiments, the first plurality of switches may include four switches arranged in a first preset pattern, such as a line shape. For example, the four switches may include a first switch, a second switch, a third switch, and a fourth switch. Each of the four switches may be represented by a corresponding number, such as a number of 1, a number of 2, a number of 3, and a number of 4 as shown in FIG. 2. The first plurality of switches may further include a fifth switch and a sixteenth switch, which are represented by a number of 5 and a number of 16 respectively.

In some embodiments, the second plurality of switches may include four switches arranged in a second preset pattern, such as a line shape. For example, the four switches may include a ninth switch, a tenth switch, a twelfth switch, and a fourteenth switch. Each of the four switches may be represented by a corresponding number, such as a number of 9, a number of 10, a number of 12, and a number of 14 as shown in FIG. 2.

Furthermore, the second plurality of switches may further include four switches arranged in a third preset pattern, such as a line shape. For example, the four switches may include an eighth switch, an eleventh switch, a thirteenth switch, and a fifteenth switch. Each of the four switches may be represented by a corresponding number, such as a number of 8, a number of 11, a number of 15 as shown in FIG. 2. In some embodiments, the four switches arranged in the third preset pattern may be arranged below/beneath the four switches arranged in the second preset pattern. In some embodiments, the second plurality of switches may further include a seventh switch, a seventeenth switch, and an eighteenth switch, which are represented by a number of 7, a number of 17, and a number of 18 respectively.

In one or more embodiments, the first plurality of switches in the first switch combination area A1 may be controlled by a user's left hand, the second plurality of switches in the second switch combination area A2 may be controlled by the user's right hand. The four switches in the first switch combination are arranged in the first preset pattern to adapt to the operating feel of the user's left hand, the eight switches in the second switch combination area A2 are arranged in the second preset pattern and a third preset pattern respectively to adapt to the operating feel of the user's right hand. In this way, the controller 1 may improve the user's operating experience as a whole.

In some embodiments, the control panel 12 may include a sixth switch which is represented by a number of 6 as shown in FIG. 2. The sixth switch may be located between the first switch combination area A1 and the second switch combination area A2 (e.g., having portions in both the first switch combination area A1 and the second switch combination area A2, such that the central axis L passes through the sixth switch). For example, the sixth switch is provided at the bottom of the control panel 12 on the central axis L between the first switch combination area A1 and the second switch combination area A2. In some embodiments, the sixth switch may be arranged at the bottommost position of the first switch combination area A1 and the second switch combination area A2. In some embodiments, the sixth switch may be arranged at a location near the bottom of the control panel 12 of the first switch combination area A1 and the second switch combination area A2, only higher than the seventh switch.

In some embodiments, the second preset pattern and the third preset pattern may be a line gradually rising. For example, the ninth switch, the tenth switch, the twelfth switch, and the fourteenth switch may be arranged in a line that is slightly inclined outwardly (e.g., from the left side of the control panel 12 to the right side of the control panel 12). In this embodiment, the control panel 12 may have a first side and a second side opposite the first side, where the central axis L is between the first side and the second side. The first switch combination area A1 may be between the first side and the central axis L of the control panel, and the second switch combination area A2 may be between the central axis L and the second side of the control panel. The second preset pattern and the third preset pattern for the switches in the second switch combination area A2 may be a line that forms a non-perpendicular angle (or an oblique angle) with respect to the central axis L and the second side.

In other words, the position of the tenth switch is higher than the position of the ninth switch, the position of the twelfth switch is higher than the position of the tenth switch, and the position of the fourteenth switch is higher than the position of the twelfth switch. Likewise, the position of the eleventh switch is higher than the position of the eighth switch, the position of the thirteenth switch is higher than the position of the eleventh switch, and the position of the fourteenth switch is higher than the position of the twelfth switch.

In some embodiments, the second preset pattern and the third preset pattern may be a line in an arc shape. In some embodiments, the curvature of the arc in the second preset pattern and the third preset pattern may be the same. In some embodiments, the arc shape may have a curvature close to zero, and the second preset pattern and the third preset pattern may have the same curvature. For example, a radius of the curvature of the arc shape may be greater than the distance from the central axis L to the second side of the control panel 12. In this case, when a user operates the switches arranged in the second preset pattern and the switches arranged in the third preset pattern with the right hand, the hand gesture for operating the switches arranged in the second preset pattern and the switches arranged in the third preset pattern may be substantially the same, except for moving downward or upward for the switches arranged in the second preset pattern and the switches arranged in the third preset pattern. For example, the curvature of the second preset pattern and/or the third preset pattern may be increased or decreased to fit the user's need and preference to reduce the user's operation errors.

In some embodiments, the first preset pattern may be an arc shape and may be basically located on the same horizontal line as the four switches arranged in the second preset pattern. In some embodiments, the arc shape of the first preset pattern may have a curvature close to zero, and the first preset pattern may have the same curvature as the second preset pattern and/or the third preset pattern. For example, a radius of the curvature of the arc shape of the first preset pattern may be greater than the distance from the central axis L to the first side of the control panel 12. In this way, the arrangement of the first preset pattern and the second preset pattern may allow a user's left hand and right hand to be basically located on the same horizontal line when operating the corresponding switches, which may be more in line with the user's operating habits.

In some embodiments, the seventh switch may be a switch with the largest surface area and/or volume arranged in the second switch combination area A2. The seventh switch may be arranged adjacent to the sixth switch. The largest surface area herein may refer to that the seventh switch occupies the largest area on the control panel 12.

In some embodiments, the fifth switch provided in the first switch combination area A1 may be arranged adjacent to the sixth switch.

In some examples, referring to FIG. 2, the controller 1 may include 18 switches. In some embodiments, the first switch combination area A1 may be provided with 6 switches. In some embodiments, the second switch combination area A2 may be provided with 11 switches. In some embodiments, a switch (e.g. the sixth switch) may be provided between the first switch combination area A1 and the second switch combination area A2. For example, the switch may be arranged on the central axis L of the control panel 12.

In some embodiments, the sixteenth switch may be arranged above the four switches arranged in the first preset pattern. In some embodiments, the seventeenth switch and the eighteenth switch may be arranged above the four switches arranged in the second preset pattern (e.g., the ninth switch, the tenth switch, the twelfth switch, and the fourteenth switch) and the four switches arranged in the third preset pattern (e.g., the eighth switch, the eleventh switch, the thirteenth switch, and the fifteenth switch).

In some embodiments, the sixteenth switch, the seventeenth switch, and the eighteenth switch may be non-functional switches. The non-functional switch herein may refer to a switch not having any function in the initial state, but the non-functional switch may be given a function by performing certain operations. For example, if (e.g., when) a user prefers the sixteenth switch to be a switch for controlling the upward movement, the function of the sixth switch may be replaced with the sixteenth switch, so that the sixteenth switch may be used to perform the function of moving upward.

In some embodiments, the plurality of switches may be spaced apart from each other. In some embodiments, the distance between each of the plurality of switches may be substantially the same.

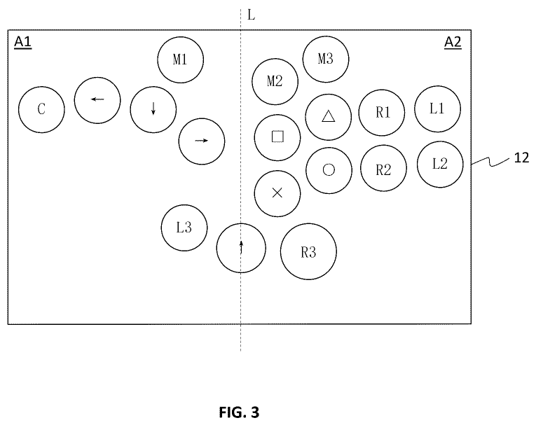

FIG. 3 is a schematic diagram of example switches of the controller, according to one or more embodiments of the present disclosure.

Referring to FIG. 3, the controller 1 may include 15 common switches and 3 non-functional switches. The 15 common switches may include four direction switches including a “↑” (up) switch, a “↓” (down) switch, a “←” (left) switch, and a “→” (right) switch; and 11 function switches including a “L1” switch, a “R1” switch, a “L2” switch, a “R2” switch, a “L3” switch, a “R3” switch, a “C” switch, a “□” switch, a “∘” switch, a “Δ” switch, and a “x” switch. The 11 function switches may include a confirmation switch, a return switch, a jump switch, and/or the like. The 11 function switches may have different functions for different consoles (such as PS5®, PS4®, PC, and/or the like). The 3 non-functional switches may be a “M1” switch, a “M2” switch, and “M3” switch. In some embodiments, each of the plurality of switches shown in FIG. 2 may correspond to each of the plurality of switches shown in FIG. 3 positionally.

The benefits of the present disclosure may include improving a user's operating experience as a whole by rearranging the existing switches.

The above are merely some specific embodiments of the present disclosure, but the scope of protection of the present disclosure is not limited thereto. A person skilled in the art can easily think of changes or substitutions within the technical scope disclosed in the present disclosure, which should be covered within the scope of protection of the present disclosure and equivalent thereof. Therefore, the scope of protection of the present disclosure shall be determined by the scope of protection of the claims and equivalents thereof.

What is claimed is:

1. A controller, wherein the controller comprises a control panel and a plurality of switches arranged on the control panel, and wherein:
the control panel comprises a first switch combination area and a second switch combination area, the first switch combination area and the second switch combination area being on opposite sides of a central axis of the control panel,
the first switch combination area comprises a first plurality of switches,
the second switch combination area comprises a second plurality of switches,
the first plurality of switches comprises one or more switches arranged in a first preset pattern, and
the second plurality of switches comprises one or more switches arranged in a second preset pattern and one or more switches arranged in a third preset pattern.

2. The controller of claim 1, wherein a sixth switch is arranged at a bottom end of the control panel between the first switch combination area and the second switch combination area.

3. The controller of claim 1, wherein:
the control panel has a first side and a second side opposite the first side, the central axis being between first side and the second side,
the second switch combination area is between the central axis and the second side of the control panel, and
the second preset pattern and the third preset pattern are a line which forms a non-perpendicular angle with respect to the central axis and the second side.

4. The controller of claim 1, wherein the second preset pattern and the third preset pattern are an arc shape having a curvature close to zero, and the second preset pattern and the third preset pattern have same curvature.

5. The controller of claim 1, wherein the one or more switches arranged in the first preset pattern are arranged in an arc shape and are substantially located on same horizontal level as the one or more switches arranged in the second preset pattern.

6. The controller of claim 2, further comprising a seventh switch with a largest surface area and/or volume arranged in the second switch combination area, and the seventh switch is arranged adjacent to the sixth switch.

7. The controller of claim 1, further comprising a fifth switch arranged in the first switch combination area, and the fifth switch is arranged adjacent to the sixth switch.

8. The controller of claim 1, further comprising:
a sixteenth switch provided above the one or more switches arranged in the first preset pattern, and
a seventeenth switch and an eighteenth switch provided above the one or more switches arranged in the second preset pattern and the one or more switches arranged in the third preset pattern.

9. The controller of claim 8, wherein the sixteenth switch, the seventeenth switch, and the eighteenth switch are non-functional switches.

10. The controller of claim 1, wherein each of the plurality of switches is spaced apart from each other.

11. A gaming system comprising a controller, wherein the controller comprises a control panel and a plurality of switches arranged on the control panel, and wherein:
the control panel comprises a first switch combination area and a second switch combination area, the first switch combination area and the second switch combination area being on opposite sides of a central axis of the control panel,
the first switch combination area comprises a first plurality of switches,
the second switch combination area comprises a second plurality of switches,
the first plurality of switches comprises one or more switches arranged in a first preset pattern, and
the second plurality of switches comprises one or more switches arranged in a second preset pattern and one or more switches arranged in a third preset pattern.

12. The gaming system of claim 11, wherein a sixth switch is arranged at a bottom end of the control panel between the first switch combination area and the second switch combination area.

13. The gaming system of claim 11, wherein:
the control panel has a first side and a second side opposite the first side, the central axis being between first side and the second side,
the second switch combination area is between the central axis and the second side of the control panel, and
the second preset pattern and the third preset pattern are a line which forms a non-perpendicular angle with respect to the central axis and the second side.

14. The gaming system of claim 11, wherein the second preset pattern and the third preset pattern are an arc shape having a curvature close to zero, and the second preset pattern and the third preset pattern have same curvature.

15. The gaming system of claim 11, wherein the one or more switches arranged in the first preset pattern are arranged in an arc shape and are substantially located on same horizontal level as the one or more switches arranged in the second preset pattern.

16. The gaming system of claim 12, wherein the controller further comprises a seventh switch with a largest surface area and/or volume arranged in the second switch combination area, and the seventh switch is arranged adjacent to the sixth switch.

17. The gaming system of claim 11, wherein the controller further comprises a fifth switch arranged in the first switch combination area, and the fifth switch is arranged adjacent to the sixth switch.

18. The gaming system of claim 11, wherein the controller further comprises:
a sixteenth switch provided above the one or more switches arranged in the first preset pattern, and
a seventeenth switch and an eighteenth switch provided above the one or more switches arranged in the second preset pattern and the one or more switches arranged in the third preset pattern.

19. The gaming system of claim 18, wherein the sixteenth switch, the seventeenth switch, and the eighteenth switch are non-functional switches.

20. The gaming system of claim 11, wherein each of the plurality of switches is spaced apart from each other.
